(19) United States
(12) Patent Application Publication
(10) Pub. No.: US 2012/0007914 A1
(43) Pub. Date: Jan. 12, 2012

(54) PRINTING METHOD

(75) Inventors: Madoka Eboshi, Nagano (JP); Satoshi Takezawa, Nagano (JP); Isao Tabayashi, Nagano (JP)

(73) Assignee: Mimaki Engineering Co., Ltd., Nagano (JP)

(21) Appl. No.: 13/257,597

(22) PCT Filed: Mar. 26, 2009
(86) PCT No.: PCT/JP2009/056154

§ 371 Date: Sep. 19, 2011

(51) Int. Cl. B41J 2/015

(52) U.S. Cl. 347/21

(57) ABSTRACT

A printing method that is implemented on an inkjet printer includes applying an ultraviolet curable ink on a surface of a metal.

### TECHNICAL FIELD

The present invention relates to a printing method.

### BACKGROUND ART

Conventionally, when printing a printed object (a character or an image) having a metallic luster by using the techniques such as the pad printing, the gravure printing, or the screen printing, an ink containing metallic particles of aluminum, etc. (hereafter, “metallic ink”) as a pigment is used (see Patent Documents 1 to 4).

Patent Document 1: Japanese Patent Application Laid-open No. H9-279078.

Patent Document 2: Japanese Patent Application Laid-open No. 2001-115061.

Patent Document 3: Japanese Patent Application Laid-open No. 2005-162771.

Patent Document 4: Japanese Patent Application Laid-open No. 2006-69094.

Patent Document 5: Japanese Patent Application Laid-open No. 2006-27193.

Patent Document 6: Japanese Patent Application Laid-open No. 2006-27194.

Patent Document 7: Japanese Patent Application Laid-open No. 2002-103800.

### DISCLOSURE OF INVENTION

### Problem to be Solved by the Invention

A dispersibility of metallic particles in the metallic ink is lower than a dispersibility of a pigment in an ink (hereinafter, “non-metallic ink”) that contains a pigment other than the metallic particles. That is, the metallic ink has a drawback that spreading of the pigment is unstable and the pigment easily settles out as compared to that in the non-metallic ink. This posed a problem for using the metallic ink in the conventional inkjet printers. If the metallic ink is used in the conventional inkjet printers, additional functions need to be added to these inkjet printers to take care of the above issue. This leads to a great increase in the development costs.

A method of imparting a luster to a printed object by printing the printed object with a mixture of a colored ink and a transparent ink using an inkjet printer is disclosed in Patent Documents 5 to 7. However, even this method does not impart a desired luster to the printed object.

The present invention has been made in view of the above discussion. It is an object of the present invention to provide a printing method that allows printing of a printed object having a metallic luster even without using the metallic ink.

### Means for Solving Problem

To achieve the above object, a printing method according to the present invention is implemented on an inkjet printer and includes applying an ultraviolet curable ink on a surface of a metal. By printing the printed object with the ultraviolet curable ink that has been applied on the surface of the metal, a metallic luster of the surface of the metal that is a printing medium (a member on which printing is to be performed) transmits through a printed object. That is, according to the present invention, a fake metallic luster that is derived from the surface of the metal can be given to the printed object.

The above invention includes subjecting the surface of the metal to a degreasing process, and forming a coating of a coupling agent onto the surface that has been subjected to the degreasing process. It is preferable that the ultraviolet curable ink be applied on the surface that has the coating of the coupling agent. By applying the ultraviolet curable ink on the surface of the metal coated with the coupling agent after performing the degreasing process, a metallic luster of the printed object becomes significant, and an adhesion between the printed object and the surface of the metal can be improved.

In the above invention, it is preferable that the coupling agent has an acryloxy group or a methacryloxy group. By doing so, the adhesion between the printed object and the surface of the metal can be improved significantly.

In the above invention, it is preferable that a transmissivity to visible light of the printed object, which is printed by applying the ultraviolet curable ink on the surface, be adjusted to 20% or above. By doing so, the metallic luster of the printed object becomes significant.

In the above invention, it is preferable that an overcoat layer be formed onto the ultraviolet curable ink that has been applied on the surface. By doing so, a surface of a printed character can be made flat. Moreover, by forming the overcoat layer, advantages such as giving a satin finish to the surface of the printed object, providing more glossiness to the printed object, or giving a wet feeling to the surface of the printed object, etc. can be achieved.

In the above invention, it is preferable that the overcoat layer be formed onto the ink before the ultraviolet curable ink that has been applied on the surface is cured. By doing so, a flatness of the surface of the printed object improves further.

### Advantages of the Invention

The present invention provides a printing method that allows printing of a printed object having a metallic luster even without using a metallic ink.

### Means for Solving Problems

Exemplary embodiments of the present invention are explained below. Meanwhile, the present invention is by no means limited to the embodiments explained below.

A printing method according to the present embodiment is implemented on an inkjet printer. The printing method according to the present embodiment involves first subjecting a surface of a metal plate that is a printing medium to a degreasing process.

A desired bonding strength can be secured between the surface of the metal plate and an ultraviolet curable ink (hereinafter, “UV ink”) by subjecting the surface of the metal plate to the degreasing process. Furthermore, the metallic luster on the surface of the metal plate is improved in comparison to the same before the degreasing process.

The metal constituting the metal plate can be aluminum, stainless steel, copper, or silver. Specifically, when a metal plate made of a metal that is easily oxidized such as aluminum, iron, or copper is used, because an oxidized film on the surface of the metal plate can be removed by subjecting the surface of the metal plate to the degreasing process, the metallic luster on the surface of the metal plate is significantly improved in comparison to the same before the degreasing process. Moreover, reoxidation of the surface of the metallic plate can be suppressed by printing the printed object on the surface of the metal plate from which the oxidation layer has been removed. Consequently, the metallic luster of the printed object can be maintained for a long duration when the metal plate made of aluminum, iron, or copper is subjected to the degreasing process in comparison to when it is not subjected to the degreasing process.

Concrete examples of the degreasing process can include immersing the metal plate in a 10%-concentrated hydrochloric acid bath, or mechanically polishing the metal plate.

In the present embodiment, a UV ink is adhered to the surface of the metal plate after subjecting the surface to the degreasing process and to a process using a coupling agent. Concretely, the UV ink is sprayed on the surface of the metal plate from a nozzle provided in a lower portion of an inkjet head while moving the metal plate on a platen or moving a carriage (head unit) mounted on an inkjet head over the metal plate. The UV ink is applied on a predetermined location on the surface of the metal plate in the form of dots. Subsequently, the UV ink is cured by illuminating an aggregate of the dot-shaped UV ink with an ultraviolet light. As a result, a printed object having a metallic luster that is derived from the surface of the metal plate is printed.

In the present embodiment, because the metallic luster of the printed object is derived from the printing medium that is the metal plate, the UV ink itself that is used to print the printed object need not have a metallic luster. That is, in the present embodiment, a fake metallic luster is imparted to the printed object although a UV ink that does not contain a metallic pigment or a UV ink that contains less metallic pigment as compared to the conventional UV ink is used.

An ink containing a coloring agent, a monofunctional monomer or a multifunctional monomer, a photopolymerization initiator, or a sensitizer can be used as the UV ink.

A dye or a pigment can be used as the coloring agent. An azo dye, a phthalocyanine dye, and an anthraquinone dye are preferable as the dye. An azo pigment such as an azo lake pigment, an insoluble azo pigment, a condensed azo pigment, and a kiretoazo pigment; a polycyclic pigment such as a phthalocyanine pigment, an anthraquinone pigment, a quinacridone pigment, an isoindoline pigment, a thioindigo pigment, a dioxazine pigment, and a quinophthalone pigment; a dye lake such as a basic dye lake and an acidic dye lake; an organic pigment such as a nitro pigment, a nitroso pigment, and aniline black; and an inorganic pigment such as titanium oxide, iron oxide, and carbon black are preferable as the pigment.

For example, acrylate or methacrylate, etc. having a substituent such as methyl, ethyl, propyl, butyl, 2-ethylhexyl, octyl, nonyl, dodecyl, glycidyl, isobornyl, and dicyclopentanyl is preferable as the monofunctional monomer.

For example, a diacrylate such as 1,3-butylene glycol, 1,4-butanediol, 1,5-pentanediol, 3-methyl-1,5-pentanediol, 1,6-hexanediol, 1,8-octanediol, 1,9-nonanediol, ethylene glycol, propylene glycol, dipropylene glycol, tripropylene glycol, and polypropylene glycol; an acrylate or a methacrylate, etc. such as methacrylate, tris (2-hydroxyethyl)isocyanurate are preferable as the multifunctional monomer.

In practice, ink properties are adjusted by combining a plurality of monomers selected from the above-mentioned monomers.

For example, a photopolymerization initiator, etc. having a benzyl group such as benzoin isobutyl ether, 2,4-diethylthioxanthone, 2-isopropylthioxanthone, 2,4,6-trimethylbenzoyl diphenyl phosphine oxide, bis (2,6-dimethoxybenzoyl)-2,4,4-trimethylpentyl phosphine oxide is preferable as the photopolymerization initiator. A combined usage of 1-hydroxycyclohexyl phenyl ketone, 2-hydroxy-2-methyl-1-phenylpropane-1-one, etc. is permissible as a photopolymerization initiator of a molecule cleavage type. Moreover, a combined usage of benzophenone, 4-phenyl benzophenone, isophthalate phenone, etc. is permissible as a photopolymerization initiator of a hydrogen abstraction type.

For example, amines, etc. such as trimethylamine, methyldimethanolamine, and triethanolamine N,N-dimethyl benzylamine are preferable as the sensitizers that are used in combination with the photopolymerization initiator.

The UV ink can contain components other than those mentioned above, as required, such as a solvent, a conductivity adjuster, a surfactant agent, an antifoam agent, and an anti-oxidizing agent. A content of the coloring agent in the UV ink can be appropriately adjusted so that a discharge stability of the UV ink is not undermined but still a desired printing darkness and a transmissivity to visible light are attained. For example, the coloring agent can be about 0.1 mass % to 15 mass % with respect to a total mass of the UV ink. For example, an ultraviolet light irradiation unit for partial-curing and an ultraviolet light irradiation unit for formally curing that are mounted on the carriage can be used to illuminate the UV ink with the ultraviolet light.

In the present embodiment, it is preferable to provide a coating of the coupling agent on the surface of the metal plate that has been subjected to the degreasing process, and then apply the UV ink on this surface that has the coating of the coupling agent. By doing this, an adhesion between the UV ink and the metallic surface can be improved. Because an amount of the coupling agent applied on the metal plate is minute, the coating of the coupling agent does not affect a transparency of the metallic luster.

For example, a coupling agent having an acryloxy group or a methacryloxy group in an hydrophobic group such as 3-methacryl oxypropyl methyl dimethoxysilane, 3-methacryloxypropyl trimethoxysilane, 3-methacryloxypropyl methyl diethoxysilane, 3-methacryloxypropyl triethoxysilane, and 3-acryloxypropyl trimethoxysilane are preferable as the coupling agent. An adhesion between the UV ink and the metallic surface can be significantly improved when the coupling agent has the acryloxy group or the methacryloxy group.

In the present embodiment, it is preferable to adjust the transmissivity to visible light of the printed object that is printed on the surface of the metal plate to 20% or above. By doing so, light falling on the printed object can easily pass through the printed object and reach the surface of the metal plate, and the light reflected from the surface of the metal plate (metallic luster) can easily pass through the printed object and emerge out of the printed object. Consequently, the fake metallic luster of the printed object becomes significant. Light cannot easily pass through the printed object when the transmissivity to visible light is below 20%; therefore, the light cannot easily pass through the printed object and reach the surface of the metal plate, and the light reflected from the surface of the metal plate cannot easily pass through the printed object and emerge out of the printed object. That is, the metallic luster of the metal plate transmits to lesser extent through the printed object when the transmissivity to visible light is below 20% than when the transmissivity to visible light is 20% or above.

The transmissivity to visible light of the printed object can be adjusted based on the factors such as a content of or a color of the coloring agent in the UV ink, and a coverage rate of the UV ink.

In the present invention, it is preferable to form a transparent overcoat layer onto the UV ink by printing a transparent ink on the UV ink that has been applied on the surface of the metal plate. The overcoat layer can flatten the surface of the printed characters. Moreover, a texture of the surface of the printed characters can be changed as desired by adjusting a coverage rate of the transparent ink. For example, the surface of the printed object can be given a satin finish by setting the coverage rate of the transparent ink below 5%. On the other hand, the surface of the printed object can be given a glossy and wet feeling by setting the coverage rate of the transparent ink to 40% or above. Meanwhile, the advantages according to the present invention can be achieved even by setting the coverage rate of the transparent ink between 5% and 40%.

An ink obtained by removing the coloring agent from the UV ink can be used as the transparent ink. Printing with the transparent ink can be performed by using a dedicated inkjet head for the transparent ink that is mounted on the carriage.

In the present invention, it is preferable to form the overcoat layer by printing the transparent ink onto the UV ink before formally curing the UV ink that has been applied on the surface of the metal plate. Concretely, it is preferable to print the transparent ink after the UV ink is partially cured, but before the partially cured ink is completely cured. Because the partially cured UV ink is in a liquid state, the transparent ink blends well with the partially cured UV ink as compared to the completely cured UV ink. Therefore, a printed object having a flat surface with no irregularities such as bands can be obtained by printing the transparent ink before the UV ink is cured in comparison to a case where the transparent ink is printed after the UV ink is cured.

The present invention is concretely explained below by using concrete examples and comparative examples. Meanwhile, the present invention is by no means limited to the concrete examples explained below.

### CONCRETE EXAMPLE 1

### Measurement of Transmissivity to Visible Light

A UV ink that contained only a cyan pigment as the pigment was applied on a transparent PET (polyethylene terephthalate) plate to form a printed object on the PET plate. An inkjet printer UJF-605C manufactured by Mimaki Engineering Co., Ltd. was used to perform the printing. An ink of SPC-0371 series manufactured by Mimaki Engineering Co., Ltd. was used as the UV ink. A printing mode was set to 1200 dpi/16 pass/Hi. A coverage rate (printing density) of the UV ink is shown in Table 1.

A transmissivity to visible light of the printed object that was printed on the transparent PET plate was measured. The transmissivity to visible light according to Concrete Example 1 is shown in Table 1. An ultraviolet-visible-infrared spectrophotometer V-650 manufactured by JASCO Corporation was used to measure the transmissivity to visible light.

Measurement of Glossiness

A surface of a stainless steel plate (SUS plate) was subjected to the degreasing process by polishing. A coupling agent was applied on the polished surface of the SUS plate. A UV primer GM-1 (a coupling agent of a silane group and having an acryloxy group) manufactured by Mimaki Engineering Co., Ltd. was used as the coupling agent.

A UV ink jet was applied on the surface of the SUS plate that has the coating of the coupling agent, and a printed object was printed by curing the UV ink with an ultraviolet light. The inkjet printer UJF-605C was used to perform the printing. The UV ink that was used in the measurement of the transmissivity to visible light was used as the UV ink. A printing mode was set to 1200 dpi/16 pass/Hi. A coverage rate of the UV ink is shown in Table 1.

A glossiness of the printed object printed on the SUS plate was measured. The glossiness is an index of a metallic luster. The glossiness in Concrete Example 1 is shown in Table 1. A gloss meter GM-268 manufactured by Konica Minolta Holdings, Inc., was used for measuring the glossiness. An angle of incidence of a light was set to 20 degrees in the measurement of the glossiness.

Evaluation of Metallic Luster

The metallic luster of the printed object that was printed on the surface of the SUS plate was inspected visually. The result is shown in Table 1. In Table 1, “C” indicates that the metallic luster was not observed, “B” indicates that the metallic luster was observed, and “A” indicates that the metallic luster was observed and it was more prominent than that in “B”.

### CONCRETE EXAMPLES 2 TO 8 AND COMPARATIVE EXAMPLES 1 TO 8

In Concrete Example 2 and Comparative Example 2, a magenta ink was used as the UV ink instead of the cyan ink according to Concrete Example 1, and the printed object was printed with a coverage rate of 100%.

In Concrete Example 3 and Comparative Example 3, a yellow ink was used as the UV ink instead of the cyan ink according to Concrete Example 1, and the printed object was printed with a coverage rate of 100%.

In Concrete Example 4 and Comparative Example 4, a light cyan ink was used as the UV ink instead of the cyan ink according to Concrete Example 1, and the printed object was printed with a coverage rate of 100%.

In Concrete Example 5 and Comparative Example 5, a light magenta ink was used as the UV ink instead of the cyan ink according to Concrete Example 1, and the printed object was printed with a coverage rate of 100%.

In Concrete Example 6 and Comparative Example 6, each of a light cyan ink, a light magenta ink, a yellow ink, and a black ink were used as the UV ink, and the printed object was printed with a coverage rate of 28%, 20%, 6%, and 5%, respectively.

In Concrete Example 7 and Comparative Example 7, a black ink was used as the UV ink instead of the cyan ink according to Concrete Example 1, and the printed object was printed with a coverage rate of 100%.

In Concrete Example 8 and Comparative Example 8, a white ink was used as the UV ink, and the printed object was printed with a coverage rate of 100%.

In Comparative Examples 1 to 8, a white PET resin plate was used as a printing material instead of the SUS plate for measurement of the glossiness.

A transmissivity to visible light for each coverage rate in Concrete Examples 2 to 8 and Comparative Examples 1 to 8 was measured with the same method as that of Concrete Example 1 except with the above-mentioned differences. The results are shown in Table 1. Moreover, printing was performed, a glossiness was measured, and a metallic luster was evaluated for Concrete Examples 2 to 8 and Comparative Examples 1 to 8 with the same method as that of Concrete Example 1 except with the above-mentioned differences. The results are shown in Table 1.

TABLE 1

| | | Printing | Coverage | Transmissivity to | Glossiness | Metallic |
|---|---|---|---|---|---|---|
| Table 1 | Ink Type | Medium | Rate (%) | Visible Light (%) | (degree) | Luster |
| Concrete | cyan | SUS plate | 100 | 25.1 | 6.8 | A |
| Example 1 | | | | | | |
| Concrete | magenta | SUS plate | 100 | 35.0 | 8.0 | A |
| Example 2 | | | | | | |
| Concrete | yellow | SUS plate | 100 | 41.6 | 23.0 | A |
| Example 3 | | | | | | |
| Concrete | light cyan | SUS plate | 100 | 57.3 | 24.4 | A |
| Example 4 | | | | | | |
| Concrete | light magenta | SUS plate | 100 | 58.6 | 18.1 | A |
| Example 5 | | | | | | |
| Concrete | light cyan 28%, | SUS plate | 59 | 30.6 | 10.8 | A |
| Example 6 | light magenta 20%, | | | | | |
| | yellow 6%, | | | | | |
| | black 5% | | | | | |
| Concrete | black | SUS plate | 100 | 6.1 | 1.2 | B |
| Example 7 | | — | 35 | 25.2 | — | — |
| Concrete | white | SUS plate | 100 | 0.2 | 4.2 | B |
| Example 8 | | — | 15 | 29.2 | — | — |
| Comparative | cyan | white PET | 100 | 25.1 | 1.3 | C |
| Example 1 | | plate | | | | |
| Comparative | magenta | white PET | 100 | 35.0 | 2.9 | C |
| Example 2 | | plate | | | | |
| Comparative | yellow | white PET | 100 | 41.6 | 3.8 | C |
| Example 3 | | plate | | | | |
| Comparative | light cyan | white PET | 100 | 57.3 | 3.3 | C |
| Example 4 | | plate | | | | |
| Comparative | light magenta | white PET | 100 | 58.6 | 4.2 | C |
| Example 5 | | plate | | | | |
| Comparative | light cyan 28%, | white PET | 59 | 30.6 | 2.6 | C |
| Example 6 | light magenta 20%, | plate | | | | |
| | yellow 6%, | | | | | |
| | black 5% | | | | | |
| Comparative | black | white PET | 100 | 6.1 | 1.0 | C |
| Example 7 | | plate | | | | |
| Comparative | white | white PET | 100 | 0.2 | 45 | C |
| Example 8 | | plate | | | | |

### CONCRETE EXAMPLE 9

In Concrete Example 9, an overcoat layer was formed by printing a transparent ink onto a UV ink before completely curing the UV ink that was applied on the surface of an SUS plate, and the UV ink and the transparent ink after formation of the overcoat were completely cured. Moreover, printing was performed for Concrete Example 9 with the same method as that of Concrete Example 2 except with the above-mentioned differences. A printing mode was set to 600 dpi/8 pass.

In Concrete Example 9, a coverage rate of the transparent ink was varied between 0% or above and 100% or below, and surface conditions of the printed objects were observed for each coverage rate.

It was observed that the printed object had the metallic luster even in Concrete Example 9 irrespective of what the coverage rate of the transparent ink was.

Moreover, it was confirmed that a flatness of the surface of the printed object was improved in Concrete Example 9 for every value of the coverage rate of the transparent ink as compared to that in Concrete Example 2.

In Concrete Example 9, it was observed that the surface of the printed object easily takes a satin finish having minute irregularities when the coverage rate of the transparent ink is below 5% than when the coverage rate is 5% or above. The satin finish results due to the fact that the transparent ink forms independent dots instead of entirely covering the surface of the printed object that is printed with an ultraviolet colored ink.

Moreover, in Concrete Example 9, a more prominent glossy and wet feeling of the surface of the printed object was observed when the coverage rate of the transparent ink was 40% or above than when the coverage rate was below 40%.

It was observed that the coverage rate of the transparent ink varies depending on a color, an image, a coverage rate, etc. of the printed object that is printed with the blue ink. That is, surface conditions of the transparent ink vary as the color, the image, the coverage rate, etc. of the printed object that is printed with the blue ink vary even when the coverage rate of the transparent ink is the same.

### INDUSTRIAL APPLICABILITY

As explained above, the present invention provides a printing method that allows printing of a printed object having a metallic luster even without using the metallic ink.

1. A printing method implemented on an inkjet printer, the printing method comprising applying an ultraviolet curable ink on a surface of a metal.

2. The printing method according to claim 1, further comprising:
subjecting the surface of the metal to a degreasing process; and
covering the surface that has been subjected to the degreasing process using coupling agent,
wherein the ultraviolet curable ink is applied onto the surface covered with coupling agent.

3. The printing method according to claim 2, wherein the coupling agent has an acryloxy group or a methacryloxy group.

4. The printing method according to claim 1, further comprising adjusting a transmissivity to visible light of a printed object printed by applying the ultraviolet curable ink on the surface to 20% or more.

5. The printing method according to claim 1, further comprising forming a transparent overcoat layer on the ultraviolet curable ink that has been applied on the surface.

6. The printing method according to claim 5, wherein before the ultraviolet curable ink that has been applied onto the surface is cured, the overcoat layer is formed on the ultraviolet curable ink.

7. The printing method according to claim 2, further comprising adjusting a transmissivity to visible light of a printed object printed by applying the ultraviolet curable ink on the surface to 20% or more.

8. The printing method according to claim 3, further comprising adjusting a transmissivity to visible light of a printed object printed by applying the ultraviolet curable ink on the surface to 20% or more.

9. The printing method according to claim 2, further comprising forming a transparent overcoat layer on the ultraviolet curable ink that has been applied on the surface.

10. The printing method according to claim 3, further comprising forming a transparent overcoat layer on the ultraviolet curable ink that has been applied on the surface.

11. The printing method according to claim 4, further comprising forming a transparent overcoat layer on the ultraviolet curable ink that has been applied on the surface.

12. The printing method according to claim 7, further comprising forming a transparent overcoat layer on the ultraviolet curable ink that has been applied on the surface.

13. The printing method according to claim 8, further comprising forming a transparent overcoat layer on the ultraviolet curable ink that has been applied on the surface.

14. The printing method according to claim 9, wherein before the ultraviolet curable ink that has been applied onto the surface is cured, the overcoat layer is formed on the ultraviolet curable ink.

15. The printing method according to claim 10, wherein before the ultraviolet curable ink that has been applied onto the surface is cured, the overcoat layer is formed on the ultraviolet curable ink.

16. The printing method according to claim 11, wherein before the ultraviolet curable ink that has been applied onto the surface is cured, the overcoat layer is formed on the ultraviolet curable ink.

17. The printing method according to claim 12, wherein before the ultraviolet curable ink that has been applied onto the surface is cured, the overcoat layer is formed on the ultraviolet curable ink.

18. The printing method according to claim 13, wherein before the ultraviolet curable ink that has been applied onto the surface is cured, the overcoat layer is formed on the ultraviolet curable ink.
